(19) United States
(12) Patent Application Publication
(10) Pub. No.: US 2026/0112767 A1
(43) Pub. Date: Apr. 23, 2026

(54) BATTERY PACK

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/352,849

(22) Filed: Oct. 8, 2025

(30) Foreign Application Priority Data
Oct. 22, 2024 (JP) 2024-186150

(51) Int. Cl. H01M 50/367; H01M 50/204; H01M 50/342

(52) U.S. Cl. CPC H01M 50/367; H01M 50/204; H01M 50/3425

(57) ABSTRACT

A battery pack of the present disclosure is a battery pack in which a plurality of battery cells elongated in a first direction is arranged side by side within a pack frame in a second direction perpendicular to the first direction. A plurality of gas exhaust valves each provided on an end face of a corresponding one of the battery cells in the first direction is arranged in a staggered configuration along the second direction such that the positions of the gas exhaust valves alternate in a third direction perpendicular to both the first direction and the second direction. The pack frame has a hollow structure and has a plurality of through holes at positions corresponding to the gas exhaust valves.

### CROSS-REFERENCE TO RELATED APPLICATION

This application claims priority to Japanese Patent Application No. 2024-186150 filed on Oct. 22, 2024. The disclosure of the above-identified application, including the specification, drawings, and claims, is incorporated by reference herein in its entirety.

### BACKGROUND

### 1. Technical Field

The present disclosure relates to battery packs.

### 2. Description of Related Art

Japanese Unexamined Patent Application Publication No. 2024-050559 (JP 2024-050559 A) discloses a battery pack in which battery cells are housed in a pack frame and the internal space of the pack frame also serves as a gas exhaust passage.

### SUMMARY

In the battery pack disclosed in JP 2024-050559 A, a large number of through holes is continuously provided in the pack frame having a hollow structure. Accordingly, there is room for improvement in reducing a decrease in strength of the pack frame that serves to support the weight of the battery cells.

The present disclosure has been made in view of the above issue, and an object thereof is to provide a battery pack that can use the internal space of a pack frame also as a gas exhaust passage while reducing a decrease in strength of the pack frame.

In order to resolve the above issue and achieve the object, a battery pack according to the present disclosure is a battery pack in which a plurality of battery cells elongated in a first direction is arranged side by side within a pack frame in a second direction perpendicular to the first direction. A plurality of gas exhaust valves each provided on an end face of a corresponding one of the battery cells in the first direction is arranged in a staggered configuration along the second direction such that the positions of the gas exhaust valves alternate in a third direction perpendicular to both the first direction and the second direction. The pack frame has a hollow structure and has a plurality of through holes at positions corresponding to the gas exhaust valves.

With this configuration, the battery pack according to the present disclosure can use the internal space of the pack frame also as a gas exhaust passage while reducing a decrease in strength of the pack frame.

In the above configuration, each of the gas exhaust valves may be provided at a first end of a corresponding one of the battery cells in the first direction.

This can reduce a decrease in strength of the pack frame compared to a case where the through holes are provided at the same position in the third direction and arranged continuously in the second direction in a first end of the pack frame in the first direction.

In the above configuration, the battery cells may be arranged such that the battery cells each provided with the gas exhaust valve at a first end of the battery cell in the first direction and the battery cells each provided with the gas exhaust valve at a second end of the battery cell in the first direction alternate in the second direction. The gas exhaust valves each provided at the first end of a corresponding one of the battery cells in the first direction may be arranged in the staggered configuration with respect to each other. The gas exhaust valves each provided at the second end of a corresponding one of the battery cells in the first direction may be arranged in the staggered configuration with respect to each other.

The through holes are thus distributed between the first and second ends of the pack frame in the first direction, whereby a decrease in strength of the pack frame can be reduced.

The battery pack according to the present disclosure can use the internal space of the pack frame also as a gas exhaust passage while reducing a decrease in strength of the pack frame.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of a battery pack according to a first embodiment;

FIG. 2 is a perspective view showing the left ends of a plurality of battery cells according to the first embodiment;

FIG. 3 is a perspective view of a pack frame according to the first embodiment;

FIG. 4 shows gas exhaust passages formed in the internal space of a left side frame;

FIG. 5 is a perspective view showing the left ends of a plurality of battery cells according to a second embodiment;

FIG. 6 is a perspective view showing the right ends of the battery cells according to the second embodiment; and

FIG. 7 is a perspective view of a pack frame according to the second embodiment.

### DETAILED DESCRIPTION OF EMBODIMENTS

### First Embodiment

A battery pack according to a first embodiment of the present disclosure will be described. The present disclosure is not limited to the embodiment.

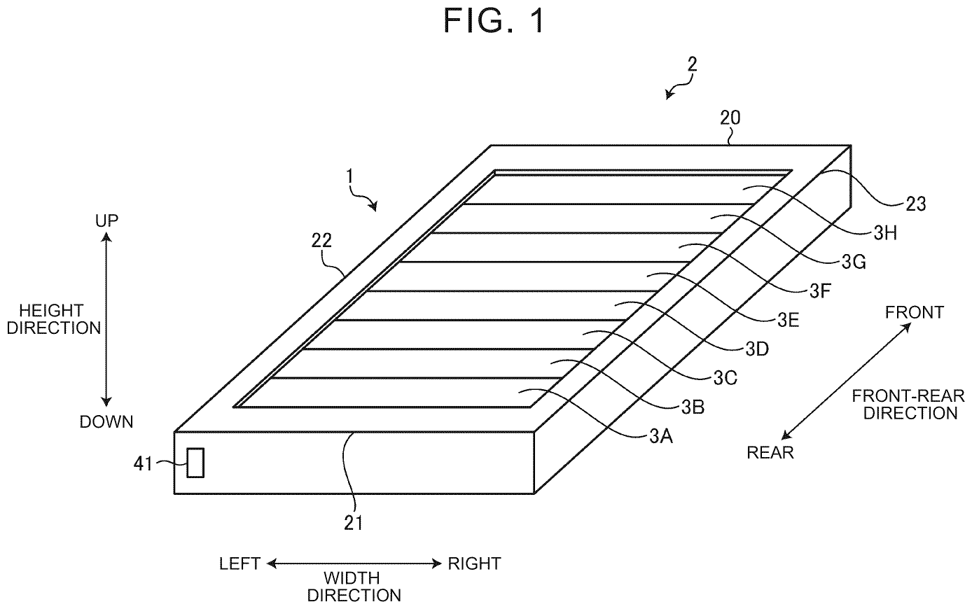

FIG. 1 shows a schematic configuration of a battery pack 1 according to the first embodiment.

In the battery pack 1 according to the first embodiment, a plurality of battery cells 3A, 3B, 3C, 3D, 3E, 3F, 3G, 3H is housed within a pack frame 2.

The battery cells 3A, 3B, 3C, 3D, 3E, 3F, 3G, 3H are prismatic cells that are elongated in a width direction, namely a first direction, of the battery pack 1. The battery cells 3A, 3B, 3C, 3D, 3E, 3F, 3G, 3H are arranged such that their longitudinal directions extend along the width direction of the battery pack 1. These battery cells are arranged side by side in the following order from the rear side toward the front side in a front-rear direction (second direction) that is perpendicular to the width direction (first direction) of the battery pack 1: battery cell 3A, battery cell 3B, battery cell 3C, battery cell 3D, battery cell 3E, battery cell 3F, battery cell 3G, and battery cell 3H. In the following description, the battery cells 3A, 3B, 3C, 3D, 3E, 3F, 3G, 3H may be collectively simply referred to as battery cell(s) 3 unless otherwise distinguished.

The pack frame 2 has a rectangular configuration in which a hollow front end frame 20, a hollow rear end frame 21, a hollow left side frame 22, and a hollow right side frame 23 are connected to each other. The front end frame 20 and the rear end frame 21 extend in the width direction of the battery pack 1 and face each other in the front-rear direction of the battery pack 1. The left side frame 22 and the right side frame 23 extend in the front-rear direction of the battery pack 1 and face each other in the width direction of the battery pack 1. Hollow extruded materials are used for the front end frame 20, the rear end frame 21, the left side frame 22, and the right side frame 23.

The left side frame 22 and the right side frame 23 are configured to support both longitudinal ends of the battery cells 3A, 3B, 3C, 3D, 3E, 3F, 3G, 3H. The front end frame 20 and the rear end frame 21 are configured to support the battery cells 3A, 3B, 3C, 3E, 3F, 3G, 3H by sandwiching them in the front-rear direction of the battery pack 1.

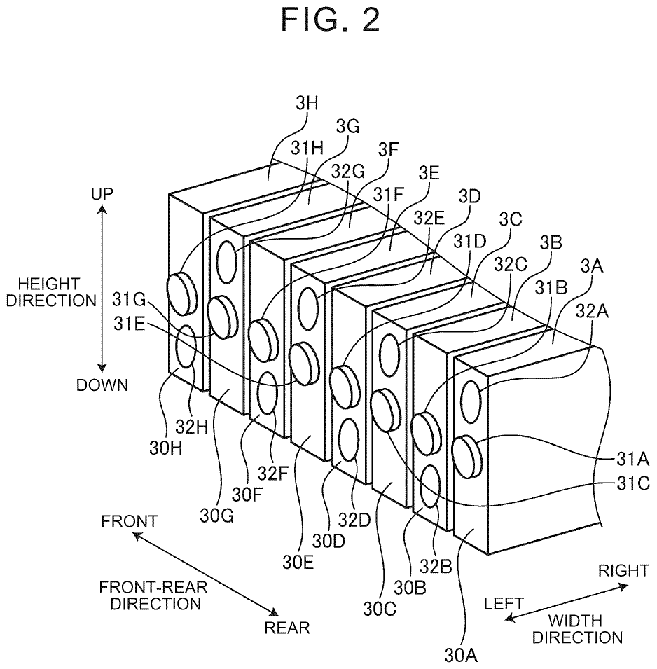

FIG. 2 is a perspective view showing the left ends of the battery cells 3A, 3B, 3C, 3D, 3E, 3F, 3G, 3H according to the first embodiment.

As shown in FIG. 2, the battery cells 3A, 3B, 3C, 3D, 3E, 3F, 3G, 3H according to the first embodiment have left end faces 30A, 30B, 30C, 30D, 30E, 30F, 30G, 30H, respectively, on their left side (i.e, at their first ends) in the width direction of the battery pack 1. Electrode terminals 31A, 31B, 31C, 31D, 31E, 31F, 31G, 31H are provided at the center in a height direction of the battery pack 1 on the left end faces 30A, 30B, 30C, 30D, 30E, 30F, 30G, 30H, respectively. The height direction of the battery pack 1 is a third direction perpendicular to both the width direction (first direction) and the front-rear direction (second direction) of the battery pack 1.

Gas exhaust valves 32A, 32B, 32C, 32D, 32E, 32F, 32G, 32H are respectively provided on the left end faces 30A, 30B, 30C, 30D, 30E, 30F, 30G, 30H. In the following description, the gas exhaust valves 32A, 32B, 32C, 32D, 32E, 32F, 32G, 32H may be collectively referred to as gas exhaust valve(s) 32 unless otherwise distinguished. The gas exhaust valve 32 is, for example, a rupture disc that ruptures to discharge gas (smoke) when the internal pressure of the battery cell 3 increases due to, for example, a short circuit inside a case of the battery cell 3. The battery cell 3 discharges gas inside the case through the gas exhaust valve 32, thereby reducing the possibility of the internal pressure of the case becoming excessively large.

The gas exhaust valves 32A, 32B, 32C, 32D, 32E, 32F, 32G, 32H are arranged in a staggered configuration along a longitudinal direction of the battery pack 1 such that their positions alternate between the upper and lower sides in the height direction of the battery pack 1. Specifically, in the sequence from the rear side toward the front side in the front-rear direction of the battery pack 1, the gas exhaust valve 32A is disposed above the electrode terminal 31A, the gas exhaust valve 32B is disposed below the electrode terminal 31B, the gas exhaust valve 32C is disposed above the electrode terminal 31C, the gas exhaust valve 32D is disposed below the electrode terminal 31D, the gas exhaust valve 32E is disposed above the electrode terminal 31E, the gas exhaust valve 32F is disposed below the electrode terminal 31F, the gas exhaust valve 32G is disposed above the electrode terminal 31G, and the gas exhaust valve 32H is disposed below the electrode terminal 31H.

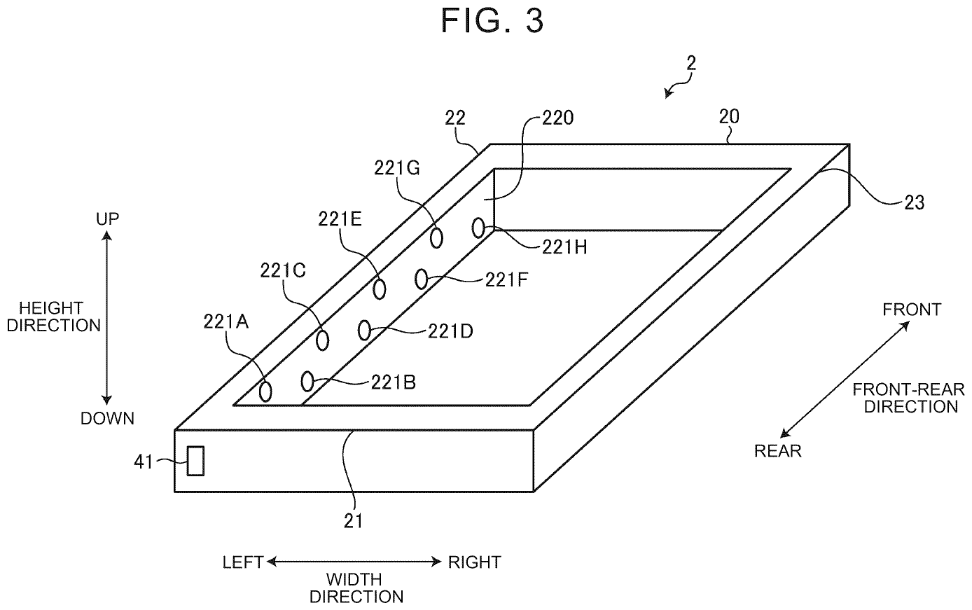

FIG. 3 is a perspective view of the pack frame 2 according to the first embodiment.

A plurality of through holes 221A, 221B, 221C, 221D, 221E, 221F, 221G, 221H is provided in an inner wall 220 of the left side frame 22 at positions corresponding to the gas exhaust valves 32A, 32B, 32C, 32D, 32E, 32F, 32G, 32H, respectively. Hereinafter, the through holes 221A, 221B, 221C, 221D, 221E, 221F, 221G, 221H may be collectively referred to as through hole(s) 221 unless otherwise distinguished.

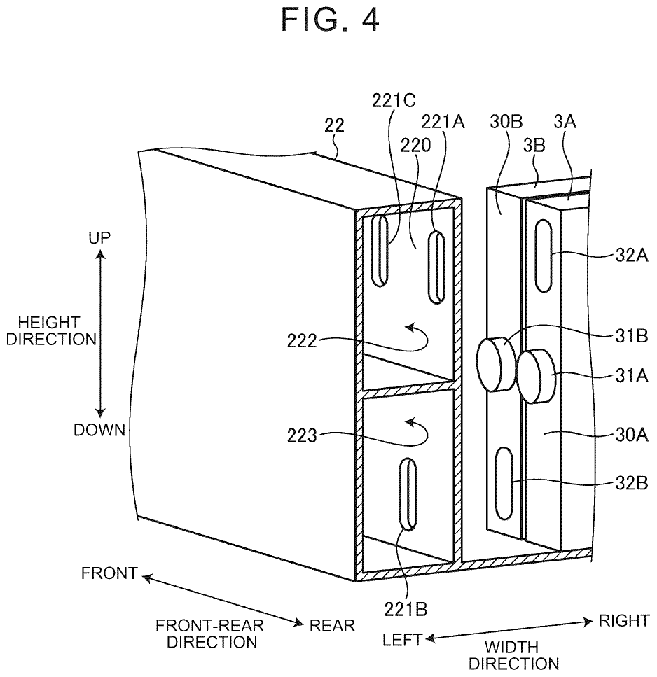

FIG. 4 shows gas exhaust passages 222, 223 formed in the internal space of the left side frame 22.

The internal space of the left side frame 22 is divided in the height direction of the battery pack 1 into the two gas exhaust passages 222, 223, namely the upper gas exhaust passage 222 and the lower gas exhaust passage 223. Of the through holes 221, the through holes 221A, 221C, 221E, 221G that are located in the upper portion in the height direction of the battery pack 1 communicate with the upper gas exhaust passage 222. Of the through holes 221, the through holes 221B, 221D, 221F, 221H that are located in the lower portion in the height direction of the battery pack 1 communicate with the lower gas exhaust passage 223. The pack frame 2 is provided with an exhaust valve 41 configured to discharge gas (smoke) flowing through the two gas exhaust passages 222, 223 to the outside. As the exhaust valve configured to discharge gas (smoke) to the outside, a single exhaust valve may be shared between the gas exhaust passages 222, 223, or two separate exhaust valves may be respectively provided for the gas exhaust passages 222, 223.

In the battery pack 1 of the first embodiment, the through holes 221A, 221B, 221C, 221D, 221E, 221F, 221G, 221H are provided in a staggered configuration in the inner wall 220 of the left side frame 22 such that their positions alternate between the upper and lower sides in the height direction of the battery pack 1. Specifically, in the sequence from the rear side toward the front side in the front-rear direction of the battery pack 1, the through hole 221A is in the upper position, the through hole 221B in the lower position, the through hole 221C in the upper position, the through hole 221D in the lower position, the through hole 221E in the upper position, the through hole 221F in the lower position, the through hole 221G in the upper position, and the through hole 221H in the lower position.

As a result, in the battery pack 1 of the first embodiment, a decrease in strength of the left side frame 22 and consequently a decrease in strength of the pack frame 2 can be reduced compared to a case where the through holes 221 are provided at the same position in the height direction and arranged continuously in the longitudinal direction (the front-rear direction of the battery pack 1) in the inner wall 220 of the left side frame 22. Accordingly, the battery pack 1 of the first embodiment can use the internal space of the pack frame 2 also as the gas exhaust passages 222, 223 while reducing a decrease in strength of the pack frame 2.

In the battery pack 1 of the first embodiment, the gas exhaust valves 32A, 32B, 32C, 32D, 32E, 32F, 32G, 32H are respectively provided on the left end faces 30A, 30B, 30C, 30D, 30E, 30F, 30G, 30H of the battery cells 3A, 3B, 3C, 3D, 3E, 3F, 3G, 3H. However, the present disclosure is not limited to this. That is, in the battery pack 1 of the first embodiment, a plurality of gas exhaust valves may be provided in the staggered configuration on the right end faces on the right side (at second ends) of the battery cells 3A, 3B, 3C, 3D, 3E, 3F, 3G, 3H in the width direction of the battery pack 1. In this case, a plurality of through holes may be provided in the staggered configuration in the right side frame 23 at positions corresponding to the gas exhaust valves, so that the hollow interior of the right side frame 23 may also serve as a gas exhaust passage.

### Second Embodiment

A battery pack according to a second embodiment of the present disclosure will now be described. In the second embodiment, the same description as in the first embodiment will be omitted as appropriate.

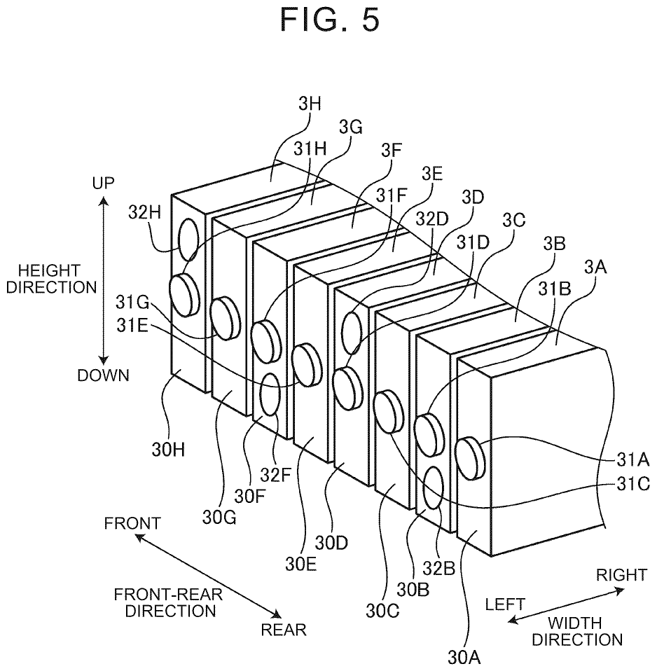

FIG. 5 is a perspective view showing the left ends of the battery cells 3A, 3B, 3C, 3D, 3E, 3F, 3G, 3H according to the second embodiment.

As shown in FIG. 5, in the second embodiment, the gas exhaust valves 32B, 32D, 32F, 32H are respectively provided on the left end faces 30B, 30D, 30F, 30H on the left side (i.e., at the first ends) of the battery cells 3B, 3D, 3F, 3H in the width direction of the battery pack 1.

The gas exhaust valves 32B, 32D, 32F, 32H are arranged in a staggered configuration along the front-rear direction of the battery pack 1 such that their positions alternate between the upper side and the lower side in the height direction of the battery pack 1. Specifically, in the sequence from the rear side toward the front side in the front-rear direction of the battery pack 1, the gas exhaust valve 32B is disposed below the electrode terminal 31B, the gas exhaust valve 32D is disposed above the electrode terminal 31D, the gas exhaust valve 32F is disposed below the electrode terminal 31F, and the gas exhaust valve 32H is disposed above the electrode terminal 31H.

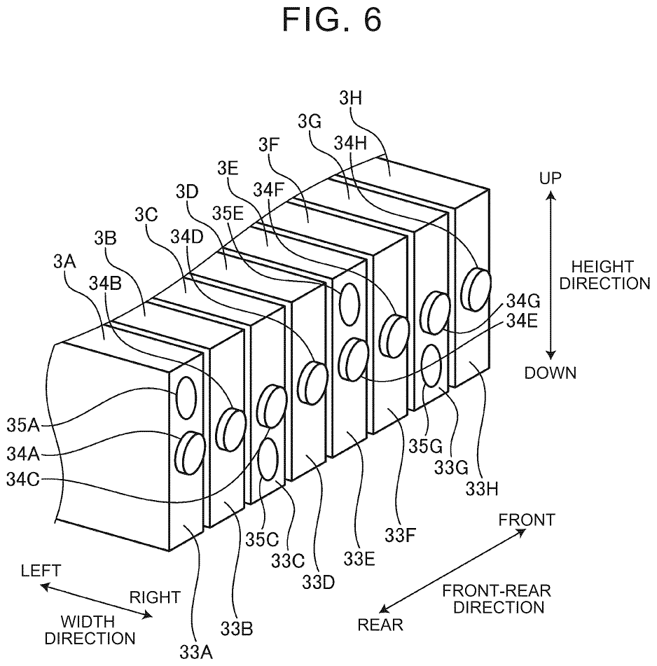

FIG. 6 is a perspective view showing the right ends of the battery cells 3A, 3B, 3C, 3D, 3E, 3F, 3G, 3H according to the second embodiment.

The battery cells 3A, 3B, 3C, 3D, 3E, 3F, 3G, 3H according to the second embodiment have right end faces 33A, 33B, 33C, 33D, 33E, 33F, 33G, 33H, respectively, on their right side (i.e, at their second ends) in the width direction of the battery pack 1. Electrode terminals 34A, 34B, 34C, 34D, 34E, 34F, 34G, 34H are provided at the center in the height direction of the battery pack 1 on the right end faces 33A, 33B, 33C, 33D, 33E, 33F, 33G, 33H, respectively.

As shown in FIG. 6, in the second embodiment, gas exhaust valves 35A, 35C, 35E, 35G are respectively provided on the right end faces 33A, 33C, 33E, 33G of the battery cells 3A, 3C, 3E, 3G. In the following description, the gas exhaust valves 35A, 35C, 35E, 35G may be collectively referred to as gas exhaust valve(s) 35 unless otherwise distinguished. Like the gas exhaust valve 32, the gas exhaust valve 35 is, for example, a rupture disc that ruptures to discharge gas (smoke) when the internal pressure of the battery cell 3 increases due to, for example, a short circuit inside a case of the battery cell 3.

The gas exhaust valves 35A, 35C, 35E, 35G are arranged in a staggered configuration along the front-rear direction of the battery pack 1 such that their positions alternate between the upper side and the lower side in the height direction of the battery pack 1. Specifically, in the sequence from the rear side toward the front side in the front-rear direction of the battery pack 1, the gas exhaust valve 35A is disposed above the electrode terminal 34A, the gas exhaust valve 35C is disposed below the electrode terminal 34C, the gas exhaust valve 35E is disposed above the electrode terminal 34E, and the gas exhaust valve 35G is disposed below the electrode terminal 34G.

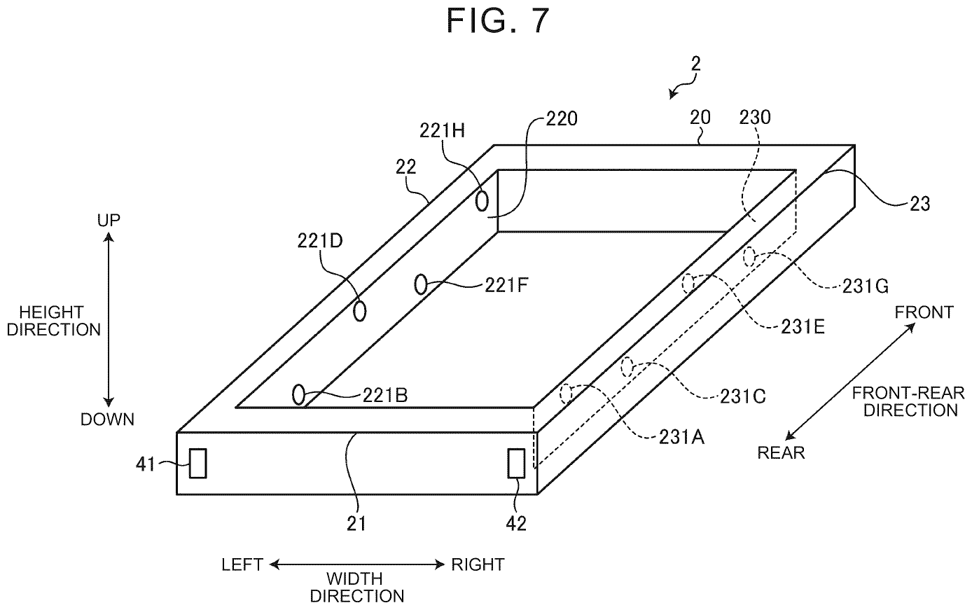

FIG. 7 is a perspective view of the pack frame 2 according to the second embodiment.

The through holes 221B, 221D, 221F, 221H are provided in the inner wall 220 of the left side frame 22 at positions corresponding to the gas exhaust valves 32B, 32D, 32F, 32H of the battery cells 3B, 3D, 3F, 3H, respectively. The through holes 221B, 221D, 221F, 221H are provided in a staggered configuration in the inner wall 220 of the left side frame 22 such that their positions alternate between the upper and lower sides in the height direction of the battery pack 1. Specifically, in the sequence from the rear side toward the front side in the front-rear direction of the battery pack 1, the through hole 221B is in the lower position, the through hole 221D in the upper position, the through hole 221F in the lower position, and the through hole 221H in the upper position.

As a result, in the battery pack 1 of the second embodiment, a decrease in strength of the left side frame 22 can be reduced compared to a case where the through holes 221B, 221D, 221F, 221H are provided at the same position in the height direction and arranged continuously in the longitudinal direction (the front-rear direction of the battery pack 1) in the inner wall 220 of the left side frame 22.

In the battery pack 1 of the second embodiment, the through holes 221B, 221D, 221F, 221H communicate with a gas exhaust passage (not shown) (e.g., the gas exhaust passages 222, 223 shown in FIG. 4) formed in the internal space of the left side frame 22. Gas (smoke) expelled from the gas exhaust valves 32B, 32D, 32F, 32H of the battery cells 3B, 3D, 3F, 3H passes through the through holes 221B, 221D, 221F, 221H, respectively, flows through the gas exhaust passage inside the left side frame 22, and is discharged to the outside via the exhaust valve 41 provided in the pack frame 2.

Through holes 231A, 231C, 231E, 231G are provided in an inner wall 230 of the right side frame 23 at positions corresponding to the gas exhaust valves 35A, 35C, 35E, 35G of the battery cells 3A, 3C, 3E, 3G, respectively. The through holes 231A, 231C, 231E, 231G are provided in a staggered configuration in the inner wall 230 of the right side frame 23 such that their positions alternate between the upper and lower sides in the height direction of the battery pack 1. Specifically, in the sequence from the rear side toward the front side in the front-rear direction of the battery pack 1, the through hole 231A is in the upper position, the through hole 231C in the lower position, the through hole 231E in the upper position, and the through hole 231G in the lower position.

As a result, in the battery pack 1 of the second embodiment, a decrease in strength of the right side frame 23 can be reduced compared to a case where the through holes 231A, 231C, 231E, 231G are provided at the same position in the height direction and arranged continuously in the longitudinal direction (the front-rear direction of the battery pack 1) in the inner wall 230 of the right side frame 23.

In the battery pack 1 of the second embodiment, the through holes 231A, 231C, 231E, 231G communicate with a gas exhaust passage (not shown) formed in the internal space of the right side frame 23. Gas (smoke) expelled from the gas exhaust valves 35A, 35C, 35E, 35G of the battery cells 3A, 3C, 3E, 3G passes through the through holes 231A, 231C, 231E, 231G, respectively, flows through the gas exhaust passage inside the right side frame 23, and is discharged to the outside via an exhaust valve 42 provided in the pack frame 2.

In the battery pack 1 of the second embodiment, the through holes 221, 231 are distributed between the left side frame 22 and the right side frame 23, and the through holes 221, 231 are arranged in a staggered configuration along the front-rear direction of the battery pack 1 such that their positions alternate between upper and lower positions in the height direction of the battery pack 1. As a result, in the battery pack 1 of the second embodiment, the density of the through holes 221, 231 in the inner wall 220 of the left side frame 22 and the inner wall 230 of the right side frame 23 can be reduced, whereby a decrease in strength of the left side frame 22 and the right side frame 23 and consequently a decrease in strength of the pack frame 2 can be reduced. Accordingly, the battery pack 1 of the second embodiment can use the internal space of the pack frame 2 also as a gas exhaust passage while reducing a decrease in strength of the pack frame 2.

What is claimed is:

1. A battery pack in which a plurality of battery cells elongated in a first direction is arranged side by side within a pack frame in a second direction perpendicular to the first direction, wherein:
a plurality of gas exhaust valves each provided on an end face of a corresponding one of the battery cells in the first direction is arranged in a staggered configuration along the second direction such that positions of the gas exhaust valves alternate in a third direction perpendicular to both the first direction and the second direction; and
the pack frame has a hollow structure and has a plurality of through holes at positions corresponding to the gas exhaust valves.

2. The battery pack according to claim 1, wherein each of the gas exhaust valves is provided at a first end of a corresponding one of the battery cells in the first direction.

3. The battery pack according to claim 1, wherein:
the battery cells are arranged such that the battery cells each provided with the gas exhaust valve at a first end of the battery cell in the first direction and the battery cells each provided with the gas exhaust valve at a second end of the battery cell in the first direction alternate in the second direction;
the gas exhaust valves each provided at the first end of a corresponding one of the battery cells in the first direction are arranged in the staggered configuration with respect to each other; and
the gas exhaust valves each provided at the second end of a corresponding one of the battery cells in the first direction are arranged in the staggered configuration with respect to each other.
